(19) United States
(12) Patent Application Publication
(10) Pub. No.: US 2014/0202616 A1
(43) Pub. Date: Jul. 24, 2014

(54) Manufacturing Method of PU Molded Product

(71) Applicant: MENQ-FONG SHIEH, Tainan County (TW)

(72) Inventor: MENQ-FONG SHIEH, Tainan County (TW)

(21) Appl. No.: 13/744,552

(22) Filed: Jan. 18, 2013

(51) Int. Cl. B29C 44/02

(52) U.S. Cl. CPC B29C 44/02
USPC 156/78; 427/133

(57) ABSTRACT

A manufacturing method for PU molded product, comprising: manufacturing a mould for a PU molded product; b. manufacturing a flexible release internal mould, wherein a coating is disposed on the inner surface of the flexible release internal mould; c. putting the release internal mould in the mould and pouring a PU foaming raw material, and closing the mould, wherein heat generated in the process of PU foaming can transfer the coating on the inner surface of the release internal mould to the surface of PU molded product; d, opening the mould, and separating the flexible release internal mould from the molded product to obtain a molded semi-finished product; and e. carrying out post-treatment. The manufacturing method of PU molded product can avoid the step of spraying mould release agent, reduce the harm to worker body, improve the yield and production efficiency of finished product remarkably and lower the production cost.

### TECHNICAL FIELD

The invention relates to a manufacturing method of PU (abbreviation for Polyurethane) molded product, more particularly to a manufacturing method of PU molded product with no use of mould release agent, in which a coating is sprayed or printed in a flexible release internal mould in advance to effectively shorten the time for drying the paint-sprayed mould on standing and improve the production efficiency and the finished product yield.

### BACKGROUND ART

A traditional manufacturing method of PU ((abbreviation for Polyurethane) molded product comprises the following steps of: a. manufacturing a metal or resin mould for a PU molded product; b. coating a mould release agent in the mould; c. spraying a paint in the mould and drying on standing, wherein the paint is used for hiding fine holes on the surface after PU foaming; d. pouring a PU foaming raw material into the mould for foaming on standing; e. opening the mould and taking the PU molded semi-finished product out of the mould; and f. carrying out post-treatment on the semi-finished product, e.g. repairing, polishing, varnish spraying, paint spraying and the like, to obtain the PU molded product. The traditional manufacturing method of PU molded product has the shortcomings below:

1. Due to long-term use of mould release agent, harm to worker body is present for a long time and there is a high possibility of markings on the surface of molded product, in this case, cleaning and polishing are indispensible for PU molded product, further leading to high post-treatment cost, the quality problem of paint drop in finished product and worse finished product yield.
2. To guarantee that flocculent holes on the surface of PU molded product are hidden after foaming, a paint must be sprayed in the mould at first, and pouring and foaming can only be achieved after the paint is dried on standing. The production efficiency is greatly reduced since the drying time is long.

### SUMMARY OF THE INVENTION

An objective of the invention is to overcome the shortcomings in traditional manufacturing methods of PU molded product, and provide a manufacturing method with no use of mould release agent, in which a coating is sprayed or printed in a flexible release internal mould in advance to effectively shorten the time for drying the paint-sprayed mould on standing and improve the production efficiency and the finished product yield.

Another objective of the invention is to provide a manufacturing method of PU hollow molded product.

To achieve the objectives above, the technical proposal below is adopted by the invention:

A manufacturing method of PU molded product comprises the following steps of:

a. manufacturing a mould for a PU molded product;
b. manufacturing a flexible release internal mould for the PU molded product, wherein a coating is disposed on the inner surface of the flexible release internal mould;
c. putting the release internal mould in the mould and pouring a PU foaming raw material, and closing the mould for foaming on standing, wherein heat generated in the process of PU foaming can transfer the coating on the inner surface of the release internal mould to the surface of PU molded product;
d, opening the mould and taking the PU molded product and the internal mould out of the mould together, and separating the flexible release internal mould from the molded product to obtain a molded semi-finished product; and
e. carrying out post-treatment on the semi-finished product to obtain finished product;
wherein the flexible release internal mould is molded by compounding and then plastic deformation of a plastic flaky substrate and a release film.

A manufacturing method of PU hollow molded product, comprising the following steps of:

a. manufacturing a half mould for a hollow molded product, wherein the mould comprises a male mould and a female mould, and the PU hollow molded product is subjected to foam molding in a hollow cavity subsequent to closing of the male and female moulds;
b. manufacturing a flexible release internal mould for the hollow molded product, wherein the flexible release internal mould is composed of a flexible release internal mould male mould and a flexible release internal mould female mould which are matched with the male mould and the female mould respectively, and a coating is disposed on the inner surface of the flexible release internal mould female mould;
c. fixing the release internal mould male mould in the mould on the male mould of the mould, fixing the flexible release internal mould female mould in the female mould of the mould, pouring a PU foaming raw material into the female mould, and closing the male mould of the mould for foaming on standing, wherein heat generated in the process of PU foaming can transfer the coating on the inner surface of the release internal mould to the surface of PU molded product;
d, opening the mould, taking half semi-finished products of the hollow molded product and the internal mould out of the half mould together, and peeling off the flexible release internal mould to obtain the half semi-finished products; and
e. bonding the two semi-finished products to obtain a semi-finished hollow molded product and then carrying out post-treatment to obtain the PU hollow molded product.

The flexible release internal mould is compounded by a flaky PCV substrate and a PE release film to obtain a compound film, the compound film is then plastically deformed by a plastic method or a bottle-blowing method to obtain the molded product internal mould, the release film is located on the inner surface of the internal mould, and a molded product surface paint is sprayed on the inner surface of the internal mould and then dried on standing for the purpose of future use.

The flexible release internal mould is compounded by a flaky PCV substrate and a PE release film to obtain a compound film, a coating is printed on the surface of the PE release film of the compound film, and the PE release film serves as inner surface which is plastically deformed as the molded product internal mould.

Wherein, the plastic flaky substrate is selected from flaky PVC, PET, PP, PE or composite materials of pair-wise combination, and the release film is selected from nonpolar PE or EVA film.

Adopting the technical proposal above, the manufacturing method of PU molded product according to the invention avoids using traditional mould release agents, reduce the harm to worker body, avoids markings on the surface of PU molded product, diminishes the procedures of post-treatment, and improves the finished product rate and production efficiency; meanwhile, the coating is sprayed in the flexible release internal mould in advance and then air-dried on standing, thus shortening the waiting time during production, raising the production efficiency greatly and lowering the production cost.

### BRIEF DESCRIPTION OF THE DRAWINGS

FIG. 1 is a flowchart of the method according to the invention;

FIG. 2 is a combined schematic diagram of the mould and the flexible release internal mould of a spherical PU product in embodiment 1;

FIG. 3 is a combined schematic diagram of the mould and the flexible release internal mould of a hollow pumpkin-shaped PU product in embodiment 3;

### DETAILED DESCRIPTION OF THE EMBODIMENTS

The invention will be further described in details with reference to the drawings and the embodiments.

### Embodiment 1

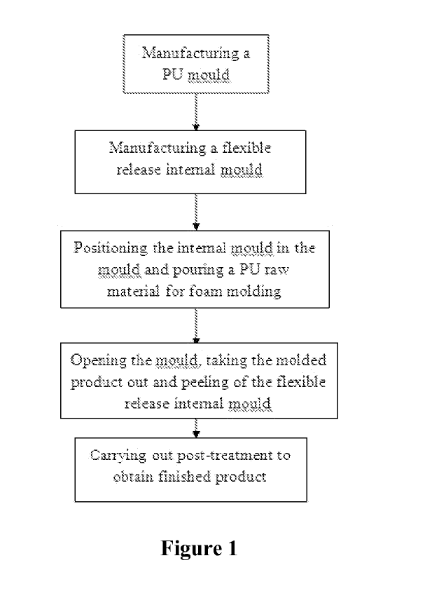

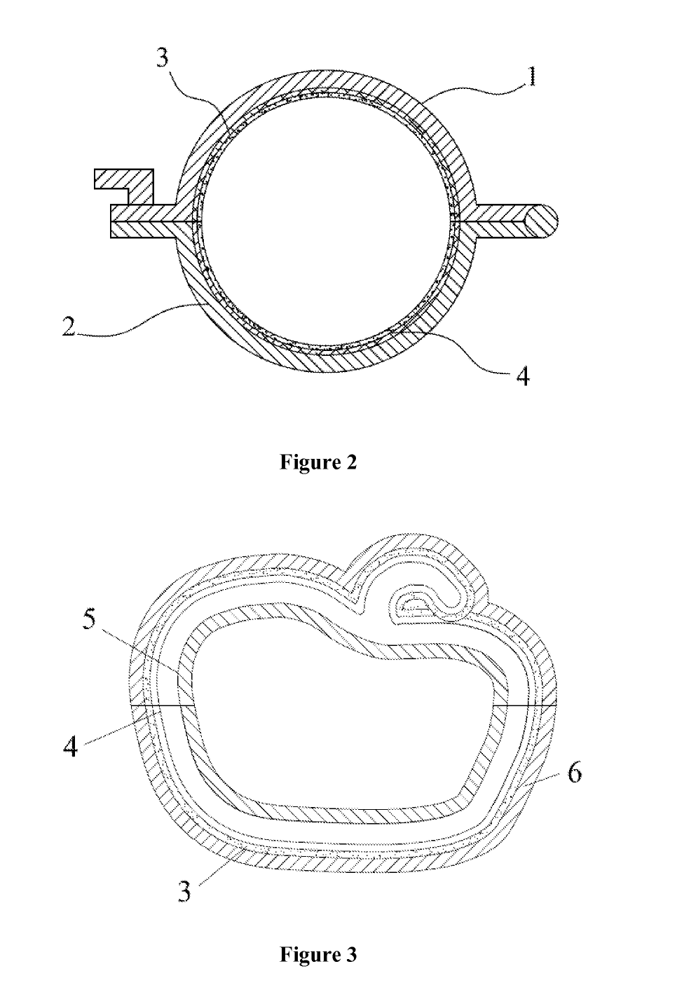

As shown in FIG. 1 and FIG. 2, in an example of spherical PU product, a manufacturing method of PU molded product comprises the following steps of:

a. manufacturing a spherical product metal mould comprising an upper mould 1 and a lower mould 2;
b. manufacturing a flexible release internal mould for the PU molded product, wherein the flexible release internal mould comprises an upper mould and a lower mould and is compounded respectively by a flaky PCV (may also be selected from flaky PVC, PET, PP, PE or composite materials of pair-wise combinations) substrate 3 and a PE (may also be selected from nonpolar PE or EVA thin film) release film 4 to obtain a compound film, the compound film is then plastically deformed by a plastic method, a molding method or a blowing method to obtain the molded product internal mould, the release film is located on the inner surface of the internal mould, and a molded product surface paint is sprayed on the inner surface of the internal mould and then dried on standing for the purpose of future use;
c. putting and fixing the release internal mould in the mould and pouring a PU foaming raw material, and closing the mould for foaming on standing, wherein heat generated in the process of PU foaming can transfer the coating on the inner surface of the release internal mould to the surface of PU molded product;
d, opening the mould and taking the molded product and the internal mould out of the mould together, and separating the flexible release internal mould from the molded product to obtain a molded semi-finished product; and
e. carrying out post-treatment (e.g. parting line elimination, paint spraying, varnish spraying, etc.) on the semi-finished product to obtain finished product.

### Embodiment 2

Also, as shown in FIG. 1 and FIG. 2, in an example of spherical PU product, a manufacturing method of PU molded product comprises the following steps of:

a. manufacturing a spherical product metal mould comprising an upper mould 1 and a lower mould 2;
b. manufacturing a flexible release internal mould for the PU molded product, wherein the flexible release internal mould comprises an upper mould and a lower mould and is compounded respectively by a flaky PCV (may also be selected from flaky PVC, PET, PP, PE or composite materials of pair-wise combinations) substrate 3 and a PE (may also be selected from nonpolar PE or EVA thin film) release film 4 to obtain a compound film, a coating is printed on the surface of the PE release film of the compound film, and the PE release film serves as inner surface which is plastically deformed as the molded product internal mould;
c. putting and fixing the release internal mould in the mould and pouring a PU foaming raw material into the mould, and closing the mould for foaming on standing, wherein heat generated in the process of PU foaming can transfer the coating on the inner surface of the release internal mould to the surface of PU molded product;
d, opening the mould and taking the molded product and the internal mould out of the mould together, and separating the flexible release internal mould from the molded product to obtain a molded semi-finished product; and
e. carrying out post-treatment (e.g. parting line elimination, paint spraying, varnish spraying, etc.) on the semi-finished product to obtain finished product.

### Embodiment 3

As shown in FIG. 1 and FIG. 3, in an example of pumpkin-shaped PU product, a manufacturing method of PU hollow molded product comprises the following steps of:

a. manufacturing a half mould for a hollow molded product, wherein the mould comprises a male mould 5 and a female mould 6, and the PU hollow molded product is subjected to foam molding in a hollow cavity subsequent to closing of the male and female moulds;
b. manufacturing a flexible release internal mould for the hollow molded product, wherein the flexible release internal mould is composed of a flexible release internal mould male mould and a flexible release internal mould female mould which are matched with the male mould 1 and the female mould 2 respectively, the flexible release internal mould is compounded by a flaky PCV substrate 3 and a PE release film 4 to obtain a compound film, the compound film is then plastically deformed by a plastic method or a bottle-blowing method to obtain the molded product internal mould, the release film is located on the inner surface of the internal mould, and a molded product surface paint is sprayed on the inner surface of the internal mould and then dried on standing for the purpose of future use;
c. fixing the release internal mould male mould in the mould on the male mould of the mould, fixing the flexible release internal mould female mould in the female mould of the mould, pouring a PU foaming raw material into the female mould, and closing the male mould of the mould for foaming on standing, wherein heat generated in the process of PU foaming can transfer the coating on the inner surface of the release internal mould to the surface of PU molded product;
d, opening the mould, taking half semi-finished products of the hollow molded product and the internal mould out of the half mould together, and peeling off the flexible release internal mould to obtain the half semi-finished products; and
e. bonding the two semi-finished products to obtain a semi-finished hollow molded product and then carrying out post-treatment to obtain the PU hollow molded product.

### Embodiment 4

Also, as shown in FIG. 1 and FIG. 3, in an example of pumpkin-shaped PU product, a manufacturing method of PU hollow molded product comprises the following steps of:

a. manufacturing a half mould for a hollow molded product, wherein the mould comprises a male mould 5 and a female mould 6, and the PU hollow molded product is subjected to foam molding in a hollow cavity subsequent to closing of the male and female moulds;
b. manufacturing a flexible release internal mould for the hollow molded product, wherein the flexible release internal mould is composed of a flexible release internal mould male mould and a flexible release internal mould female mould which are matched with the male mould 1 and the female mould 2 respectively, the flexible release internal mould is compounded by a flaky PCV substrate 3 and a PE release film 4 to obtain a compound film, a coating is printed on the surface of the PE release film of the compound film, and the PE release film serves as inner surface which is plastically deformed as the molded product internal mould;
c. fixing the release internal mould male mould in the mould on the male mould of the mould, fixing the flexible release internal mould female mould in the female mould of the mould, pouring a PU foaming raw material into the female mould, and closing the male mould of the mould for foaming on standing, wherein heat generated in the process of PU foaming can transfer the coating on the inner surface of the release internal mould to the surface of PU molded product;
d, opening the mould, taking half semi-finished products of the hollow molded product and the internal mould out of the half mould together, and peeling off the flexible release internal mould to obtain the half semi-finished products; and
e. bonding the two semi-finished products to obtain a semi-finished hollow molded product and then carrying out post-treatment to obtain the PU hollow molded product.

What is claimed is:

1. A manufacturing method of PU molded product, comprising the following steps of:
a. manufacturing a mould for a PU molded product;
b. manufacturing a flexible release internal mould for the PU molded product, wherein a coating is disposed on the inner surface of the flexible release internal mould;
c. putting the release internal mould in the mould and pouring a PU foaming raw material, and closing the mould for foaming on standing, wherein heat generated in the process of PU foaming can transfer the coating on the inner surface of the release internal mould to the surface of PU molded product;
d, opening the mould and taking the PU molded product and the internal mould out of the mould together, and separating the flexible release internal mould from the molded product to obtain a molded semi-finished product; and
e. carrying out post-treatment on the semi-finished product to obtain finished product;
wherein the flexible release internal mould is molded by compounding and then plastic deformation of a plastic flaky substrate and a release film.

2. The manufacturing method of PU molded product according to claim 1, characterized in that the flexible release internal mould is compounded by a flaky PCV substrate and a PE release film to obtain a compound film, the compound film is then plastically deformed by a plastic method or a bottle-blowing method to obtain the molded product internal mould, the release film is located on the inner surface of the internal mould, and a molded product surface paint is sprayed on the inner surface of the internal mould and then dried on standing for the purpose of future use.

3. The manufacturing method of PU molded product according to claim 1, characterized in that the flexible release internal mould is compounded by a flaky PCV substrate and a PE release film to obtain a compound film, a coating is printed on the surface of the PE release film of the compound film, and the PE release film serves as inner surface which is plastically deformed as the molded product internal mould.

4. The manufacturing method of PU molded product according to claim 1, wherein the plastic flaky substrate is selected from flaky PVC, PET, PP, PE or composite materials of pair-wise combination, and the release film is selected from nonpolar PE, PP, PET or EVA film.

5. A manufacturing method of PU hollow molded product, comprising the following steps of:
a. manufacturing a half mould for a hollow molded product, wherein the mould comprises a male mould and a female mould, and the PU hollow molded product is subjected to foam molding in a hollow cavity subsequent to closing of the male and female moulds;
b. manufacturing a flexible release internal mould for the hollow molded product, wherein the flexible release internal mould is composed of a flexible release internal mould male mould and a flexible release internal mould female mould which are matched with the male mould and the female mould respectively, and a coating is disposed on the inner surface of the flexible release internal mould female mould;
c. fixing the release internal mould male mould in the mould on the male mould of the mould, fixing the flexible release internal mould female mould in the female mould of the mould, pouring a PU foaming raw material into the female mould, and closing the male mould of the mould for foaming on standing, wherein heat generated in the process of PU foaming can transfer the coating on the inner surface of the release internal mould to the surface of PU molded product;
d, opening the mould, taking half semi-finished products of the hollow molded product and the internal mould out of the half mould together, and peeling off the flexible release internal mould to obtain the half semi-finished products; and
e. bonding the two semi-finished products to obtain a semi-finished hollow molded product and then carrying out post-treatment to obtain the PU hollow molded product.

6. The manufacturing method of PU hollow molded product according to claim 5, characterized in that the flexible release internal mould is compounded by a flaky PCV substrate and a PE release film to obtain a compound film, the compound film is then plastically deformed by a plastic method or a bottle-blowing method to obtain the molded product internal mould, the release film is located on the inner surface of the internal mould, and a molded product surface paint is sprayed on the inner surface of the internal mould and then dried on standing for the purpose of future use.

7. The manufacturing method of PU hollow molded product according to claim 5, characterized in that the flexible release internal mould is compounded by a flaky PCV substrate and a PE release film to obtain a compound film, a coating is printed on the surface of the PE release film of the compound film, and the PE release film serves as inner surface which is plastically deformed as the molded product internal mould.

8. The manufacturing method of PU hollow molded product according to claim 5, wherein the plastic flaky substrate is selected from flaky PVC, PET, PP, PE or composite materials of pair-wise combination, and the release film is selected from nonpolar PE or EVA film.
